(19) United States
(12) Patent Application Publication
(10) Pub. No.: US 2006/0246309 A1
(43) Pub. Date: Nov. 2, 2006

(54) Method for reducing dusting in hdpe

(75) Inventors: Sarah Marshall, Calgary (CA); Tony Tikuisis, Calgary (CA); Norman Dorien Joseph Aubee, Okotoks (CA); Patrick Lam, Calgary (CA)

Correspondence Address: Kenneth H. Johnson;Patent Attorney, P.O. Box 630708, Houston, TX, 77263, US

(73) Assignee: NOVA Chemicals (International) S.A.

(21) Appl. No.: 11/403,461

(22) Filed: Apr. 13, 2006

(30) Foreign Application Priority Data
Apr. 29, 2005 (CA) 2,505,894

(51) Int. Cl. C08K 3/34; B32B 27/32

(52) U.S. Cl. 428/523; 524/451; 524/543

(57) ABSTRACT

High density polyethylene (hdpe) containing from 500 to 20,000 ppm of talc is used to prepare barrier film which is resistant to water vapor transmission. The addition of talc reduces the formation of “dust” (i.e. abraded polyethylene particles) during the manufacture of packages from the barrier film. Preferred talc has a particle size of less than 10 microns.

### FIELD OF THE INVENTION

This invention relates to polyethylene compositions which are prepared by the addition of from 500 to 20,000 ppm of talc to very high density polyethylene. Films prepared from these compositions have excellent barrier properties and are resistant to “dusting”.

### BACKGROUND OF THE INVENTION

Polyethylene may be classified into two broad families, namely “random” (which is commercially prepared by initiation with free radicals) and “linear” (which is commercially prepared with a transition metal catalyst, such as a “Ziegler Natta” catalyst, or a “chromium” catalyst, or a single site catalyst or a “metallocene catalyst”).

Most “random” polyethylene which is commercially sold is homopolymer polyethylene, whereas most “linear” polyethylene which is commercially sold is copolymer of ethylene with at least one alpha olefin (especially butene, hexene or octene). The incorporation of a comonomer into linear polyethylene reduces the density of the resulting copolymer. For example, a “linear” ethylene homopolymer generally has a very high density (typically greater than 0.955 grams per cubic centimeter (g/cc)—but the incorporation of small amounts of comonomer results in the production of so-called “high density polyethylene” (or “hdpe”—typically, having densities greater than 0.935 g/cc) and the incorporation of further comonomer produces so-called “linear low density polyethylene” (or “lldpe”—typically having a density of from about 0.905 g/cc to 0.935 g/cc).

A large proportion of hdpe is used to prepare rigid molded goods (such as crates, pails and toys). Conversely, most lldpe is used to prepare flexible plastic film. One problem with lldpe film is that the film layers tend to stick together, especially on a large roll of film. This stickiness is referred to as “blocking”. Thus, a standard practice for lldpe film manufacturers is to add an “antiblock” agent such as silica, diatomaceous earth, or talc. It is generally believed that antiblock agents function by producing a rough surface which reduces the contact between film layers and makes them easier to separate.

A more detailed review in the use of talc is provided in “New Talc Antiblocks for Additive Interactions” (Drummond et al., conference proceedings from The International Conference on Additives for Polyolefins, Houston, Tex., Feb. 23-25, 1998, p. 149). Thus, the addition of talc to lldpe film is well known and widely practiced.

Some plastic film is also made from hdpe. However hdpe film typically does not exhibit blocking problems and, accordingly, antiblock is not typically used with hdpe film.

One particular type of hdpe film is used to prepare food packaging with “barrier properties”—i.e. the film acts as a “barrier” to water vapor transmission. This so-called “barrier film” is used to prepare packages (or liners for cardboard packages) for breakfast cereals, crackers and other dry foodstuffs.

The manufacture of food packages from hdpe barrier film causes the film to come in contact with various types of film production and conversion machinery. The friction which results from this contact can cause the polyethylene film to abrade, thus leaving fine particles of abraded polyethylene on the surface of the film. This condition is referred to as “dusting” because the fine hdpe particles look like dust.

The present invention mitigates the above-described dusting problem.

### SUMMARY OF THE INVENTION

In one embodiment, the present invention provides a composition for the preparation of barrier film wherein said composition comprises a high density polyethylene having a density of greater than 0.950 g/cc and from 500 to 20,000 ppm of talc.

In another embodiment, the present invention provides a barrier film having enhanced dusting resistance. A further embodiment of this invention provides a food package made from this barrier film.

### DETAILED DESCRIPTION

Barrier Film and Food Packaging

Plastic films are widely used as packaging materials for foods. Flexible films, including multilayer films, are used to prepare bags, wrappers, pouches and other thermoformed materials.

The permeability of these plastic films to gases (especially oxygen) and moisture is an important consideration during the design of a suitable food package.

Films prepared from thermoplastic ethylene-vinyl alcohol (“EVOH”) copolymers are commonly employed as an oxygen barrier and/or for resistance to oils. However, EVOH films are quite permeable to moisture.

Conversely, polyolefins, especially high density polyethylene, are resistant to moisture transmission but comparatively permeable to oxygen.

The permeability of linear polyethylene film to moisture is typically described by a “water vapor transmission rate” (or “WVTR”). In certain applications some vapor transmission is desirable—for example, to allow moisture out of a package which contains produce. The use of linear low density polyethylene (lldpe), which may be filled with calcium carbonate (to further increase vapor transmission) is common for this purpose.

Conversely, for packages which contain crispy foods such as cereals or crackers, it is desirable to limit WVTR to very low levels to prevent the food from going stale. The use of hdpe to prepare “barrier film” is common for this purpose. A review of plastic films and WVTR behavior is provided in U.S. Pat. No. 6,777,520 (McLeod et al.) This invention relates to “barrier films” prepared from hdpe—i.e. films with low MVTR. As will be appreciated from the above description of EVOH films, it is also known to prepare multilayer barrier films to produce a structure which is resistant to moisture and oxygen. Multilayer structures may also contain additional layers to enhance packaging quality—for example, additional layers may be included to provide impact resistance or sealability. It will also be appreciated by those skilled in the art that “tie layers” may be used to improve the adhesion between “structural” layers. In such multilayer structures, the hdpe barrier layer is typically used as an external (“skin”) layer.

The manufacture of “barrier” food packaging from plastic resins involves two basic operations.

The first operation involves the manufacture of plastic film from the plastic resin. Most “barrier films” are prepared by “blown film” extrusion, in which the plastic is melted in an extruder, then forced through an annular die. The extrudate from the annular die is subjected to blown air, thus forming a plastic bubble. The use of multiple extruders and concentric dies permits multilayer structures to be co-extruded by the blown film process. The “product” from this operation is “barrier film” which is collected on rolls and shipped to the manufactures of food packaging.

The manufacture of the food packaging generally converts the rolls of blown film into packaged foods. This typically involves three basic steps:

1) forming the package;

2) filling the package;

3) sealing the food in the finished package.

Although the specific details will vary from manufacturer to manufacturer, it will be readily appreciated that the film comes into contact with many machine pieces during the fabrication of the filled package. The resulting frictional forces often cause hdpe barrier films to abrade. This phenomenon is referred to as “dusting” because the pieces of abraded plastic resemble dust particles.

“Dusting” is a problem for packaging manufacturers because the build-up of “plastic dust” can force the shutdown of packaging machinery for cleaning.

We have now discovered that this problem may be mitigated by the addition of talc to the hdpe resin which is used to prepare the barrier film.

Talc

As previously noted, it is known to use talc as an antiblock for low density polyethylene (to prevent layers of low density polyethylene in a roll from sticking together). However, the high density polyethylene which is used to prepare barrier resin does not suffer from a blocking problem, so antiblock is not generally added to hdpe film.

Moreover, it will be appreciated by those skilled in the art that the following other inorganic materials are well known to provide antiblock functionality in low density polyethylene: diatomaceous earth, silica, calcium carbonate and ceramic microspheres (such as those sold under the trademark Zeeospheres™ by 3M). However, the present invention does not contemplate the use of these other known antiblock agents as a replacement for the talc which is required.

Those commercially available talcs which are used as antiblocks are preferred for use in the present invention. Preferred talcs have a median particle size of less than 10 microns. Talc having a larger particle size is still an effective anti-dusting agent (as illustrated by the examples) but the larger sized talc particles are generally more difficult to disperse. Talc agglomerates in the barrier film may cause “gels” (which, in turn, may diminish the barrier performance and the physical properties of the film—particularly moisture barrier performance and impact strength).

The preferred concentration of talc is from 500 to 20,000 parts per million by weight (hereinafter “ppm”). Preferred concentrations are from 1,000 to 10,000 ppm. Lower concentrations may reduce the anti-dusting performance and higher concentrations become increasingly difficult to disperse—which may lead to the agglomerate/gel problem noted above.

The “aspect ratio” of various talcs has also been studied but has not been found to make a large difference in anti-dusting performance.

Whilst not wishing to be bound by theory, it is believed that the talc in the barrier film reduces the abrasive forces between the packaging machinery and the plastic film surface, thereby reducing the amount of “dust” being formed.

HDPE Type

The plastic used in the barrier film of this invention is a high density polyethylene (hdpe). Specifically, the hdpe must have a density of at least 0.950 grams per cubic centimeter (“g/cc”) as determined by ASTM D1505. Preferred hdpe has a density of greater than 0.955 g/cc and the most preferred hdpe is a homopolymer of ethylene.

The melt index, “I₂”, of the hdpe is from 0.1 to 50 (preferably from 0.3 to 10) grams per 10 minutes as determined by ASTM D1238 (at 190° C. with a 2.16 Kg weight), with a melt index of from 0.3 to 5 grams per 10 minutes being most preferred.

Commercially available examples of hdpe which are suitable for use in the present invention include:

| | | Melt Index, I₂¹ | Density² |
|---|---|---|---|
| Trademark | Company | (g/10 minutes) | (g/cc) |
| MarFlex ™ 9659 | Chevron Phillips | 1.0 | 0.962 |
| Alathon ™ L5885 | Equistar | 0.85 | 0.958 |
| SCLAIR ™ 19G | NOVA Chemicals | 1.2 | 0.96 |
| | Corporation | | |

¹ASTM D1238 (190° C./2.16 Kg)
²ASTM D1505

It is preferred to use hdpe which is produced in a solution polymerization process. Qualitatively, this type of hdpe produces barrier film having excellent barrier performance (i.e. low MVTR) but poor dusting performance (in the absence of talc). Particularly preferred hdpe is a homopolymer which is prepared in a dual reactor solution polymerization process with a single site catalyst system. Details of the process are disclosed in Canadian patent application 2,479,704 (Swabey et al.).

Other Additives

The hdpe may also contain other conventional additives, especially
(1) primary antioxidants (such as hindered phenols, including vitamin E);
(2) secondary antioxidants (especially phosphites and phosphonites); and
(3) process aids (especially fluoroelastomer and/or polyethylene glycol bound process aid).

Further details are provided by the following non-limiting examples.

### EXAMPLES

### Example 1

### Screening

Screening experiments to test the effect of various additives on hdpe film were conducted by preparing blown film on a line manufactured by Macro Engineering and Technology of Mississauga, Ontario, Canada. The line was operated with an annular die having a 100 mil die gap and a blow up ratio (BUR) of 2.5:1 was used to prepare film having a thickness (aiming point) of 1.5 mils. Physical properties of the films are shown in Table 1.)

Films were prepared using an hdpe having a melt index, I₂, of 1.2 g/10 minutes and a density of 0.96 g/cc, (sold under the trademark SCLAIR 19G by NOVA Chemicals Corporation) with the following additives: none (“control”); talc (at 1,500 and 2,500 ppm); silica (at 1,500 and 2,500 ppm); a fatty amide (sold under the trademark Crodamide ER by Croda Inc., at 1,000 ppm); and zinc stearate (at 1,000 ppm). The level of “dusting” on the hdpe films was then determined as follows.

“Dusting” Test

In general, the test is undertaken by:

(1) fixing a test swatch on a stationery mount;

(2) drawing a quantity of film across the test swatch (under constant tension conditions, for a fixed period of time);

(3) observing the amount of “dust” which is deposited upon the test swatch; and (preferably)

(4) quantifying the amount of dust on the test swatch.

Additional Details Follow:

1.1 The test swatch is preferably a dark colored fabric so as to allow the “dust” accumulation to be readily observed. A fabric having a “rough” surface is also preferred. The dusting tests of this work were completed using black felt.

1.2 The test swatch was mounted on the blown film line (as described below) and the dusting tests were completed as the film was being produced. The blown film line was equipped with a number of guide rolls which are located upstream of the “film winder”. These “guide rolls” direct the movement of the film as it is being pulled by the winding mechanism. The finished roll of film is produced on a shaft/roll which is driven by the film winder. The test swatch was taped to a guide roll that had been locked—i.e. the guide roll was not permitted to rotate. Thus, the plastic film was subjected to a frictional force as it was “ragged” across the fixed test swatch.

2.1 The film line was run for 60 minutes (at an essentially constant throughput rate, and using an essentially constant tension load—as applied by the film winder). This procedure was repeated for all of the films.

3.1 “Dust” (i.e. abraded polyethylene particles) was observed during the production of all films. Qualitatively, the amount of dust which was deposited on the black felt test swatch was visibly higher for the control film (i.e. the film which was prepared without talc).

4.1 The black felt test swatch was removed at the end of each 60 minute test. A quantitative result was then obtained as follows.

4.2 A section of the test swatch was photographed with a digital camera. The resulting digital image was then analyzed to measure the percentage of the surface which was white (indicating “dust” deposits) and the percentage which remained black. At least two representative sections of each swatch were analyzed (and the results which are reported in the tables represent “average” whiteness ratings). Thus, for clarity, the comparative example in Table 3 (film 15-c) shows a “whiteness rating” of 15%—which indicates that 15% of the swatch was covered with white dust. Similarly, the inventive film 1 had a whiteness rating of 2%.

It is appreciated that these dusting needs should be completed using constant throughput rates and constant tension on the film to provide meaningful results. It may also be noted that the test does not need to be completed as the film is being produced. For example, meaningful results may be obtained by starting with a finished roll of film and transferring it onto another roller (using an unwind/rewind machine of the type well known to those skilled in the art), with a test swatch mounted between the rollers on the unwind/rewind machine.

This test procedure may be machine dependent—in the sense that the absolute value of the “whiteness rating” result may be influenced by specific machine features (as well as the time/tension parameters previously mentioned). However, this test procedure may be used to produce meaningful qualitative results—i.e. the “dusting performance” of one film in comparison to another film may be readily determined by careful use of this test.

“Whiteness rating” data are shown in Table 1 and Table 3.

TABLE 1

| Additive | Whiteness Rating |
|---|---|
| (ppm) | (%) |
| None | 12.5 |
| Talc (1,500) | 4.5 |
| Talc (2,500) | 2.5 |
| Silica (1,500) | 8.5 |
| Silica (2,500) | 9.0 |
| Fatty Amide (1,000) | 9.0 |
| Zinc Stearate (1,000) | 18.0 |

### Example 2

Further dusting experiments were conducted by preparing blown film from hdpe containing different types and concentrations of talc.

The commercially available talcs shown in Table 2 were used in this study. Particle size and aspect ratio of these talcs (based on data from the suppliers) are provided in Table 2.

TABLE 2

| | | | Median | Top Particle | |
|---|---|---|---|---|---|
| | | | Particle Size | Size | Aspect |
| Talc | Trademark | Source | (microns) | (microns) | Ratio |
| 1 | Cimpact 699 | Montana | 1.5 | 10-15 | 5:1 |
| 2 | Mistron 400C | — | 4 | 25-30 | 8:1 |
| 3 | Silverline 002 | Montana | 12.5 | 75 | 5:1 |
| 4 | Cimpact 550 | Chinese | 3.6 | 30 | 15:1 |
| 5 | Jetfil 700C | Ontario | 1.5 | 15 | 25:1 |
| 6 | Jetfil 575C | Ontario | 3.4 | 25-30 | 25:1 |
| 7 | Jetfil P150 | Ontario | 10.5 | 75 | 25:1 |

Blown films were then prepared using the “Macro film line” machinery as described in Example 1 using a blow up ratio of 2.5:1 to produce 1.5 mil (thickness) film.

The hdpe was an ethylene homopolymer having a density of 0.964 g/cc and a melt index, I₂, of 1.0 g/10 minutes. The hdpe was prepared in a reactor solution polymerization process.

“Whiteness rating” data for films prepared from these talcs (at 2,500 and 7,500 ppm) are shown in Table 3. All of the inventive films have a dusting whiteness rating which is at least 50% improved (i.e. lower) than the control film (15-c) which was produced without talc under substantially the same film extrusion condition.

TABLE 3

| | | Amount | Whiteness |
|---|---|---|---|
| Film | Talc Type | (ppm) | Rating (%) |
| 1 | 1 | 2,500 | 2 |
| 2 | 1 | 7,500 | 2 |
| 3 | 2 | 2,500 | 2 |
| 4 | 2 | 7,500 | 2 |
| 5 | 3 | 2,500 | 3 |
| 6 | 3 | 7,500 | 2 |
| 7 | 4 | 2,500 | 3 |
| 8 | 4 | 7,500 | 2 |
| 9 | 5 | 2,500 | 5 |
| 10 | 5 | 7,500 | 2 |
| 11 | 6 | 2,500 | 2 |
| 12 | 6 | 7,500 | 2 |
| 13 | 7 | 2,500 | 2 |
| 14 | 7 | 7,500 | 2 |
| 15-c | — | 0 | 15 |

The films prepared from talc 3 (Silverline 002 median particle size of 12.5 microns) and talc 7 (Jetfil P150 median particle size of 10.5 microns) had good “dusting performance”, as indicated by a low whiteness rating, but contained visible gels. Analysis of the gels confirmed that they contained talc agglomerates. Accordingly, smaller particle size talc is preferred. The remaining films, prepared using the smaller particle size talcs, did not contain unusual levels of visible gels (even at the 7,500 ppm talc loadings).

### Example 3

The hdpe films of this invention are intended for use in the manufacture of packages which provide a moisture barrier—alternatively stated, these films should have a low MVTR. Accordingly, the MVTR of several of the films prepared in Example 2 with the preferred talcs was tested and compared to a control film (prepared without talc). Water Vapor Transmission Rate (“WVTR”, expressed as grams of water vapor transmitted per 100 square inches of film per day at a specified film thickness (mils), or g/100 in²/day) was measured in accordance with ASTM F1249-90 with a MOCON permatron developed by Modern Controls Inc. at conditions of 100° F. (37.8° C.) and 100% relative humidity. The data in Table 4 suggest that these preferred talcs did not have significant effect on MVTR. The data in Table 4 indicate that the MVTR of the film prepared from the smallest particle size/lowest aspect ratio talc, namely Cimpact 699, may have improved (lower) MVTR. However, the accuracy and precision of the MVTR test are not sufficiently understood to treat this as a significant result.

TABLE 4

| Film^{x} | WVTR^{y} |
|---|---|
| 1 | 0.177 |
| 2 | 0.186 |
| 3 | 0.201 |
| 4 | 0.194 |
| 7 | 0.193 |
| 8 | 0.186 |
| 11 | 0.194 |
| 12 | 0.193 |
| 15-c | 0.197 |

^{x}film numbering corresponds to Table 3
^{y}WVTR = Water Vapor Transmission Rate (grams per 100 square inches per day), per ASTM F1249-90

What is claimed is:

1. A composition for the preparation of barrier film wherein said composition comprises a high density polyethylene having a density of greater than 0.950 g/cc and from 500 to 20,000 ppm of talc.

2. The composition of claim 1 wherein said talc has a median particle size of less than 10 microns.

3. The composition of claim 2 wherein said talc is present at a concentration of from 1,000 to 10,000 ppm.

4. The composition of claim 1 wherein said high density has a density of greater than 0.955 g/cc and a melt index, I₂, of from 0.1 to 50 as determined by ASTM D1238 at 190° C. with a 2.16 Kg weight.

5. The composition of claim 3 wherein said ethylene homopolymer is characterized by being produced in a solution polymerization process.

6. A polyethylene barrier film wherein said barrier film comprises at least one film layer which is prepared by the extrusion of a composition comprising (i) a high density polyethylene having a density of greater than 0.950 g/cc and (ii) from 500 to 20,000 ppm of talc.

7. The polyethylene barrier film of claim 6 wherein said talc has a median particle size of less than 10 microns.

8. The polyethylene barrier film of claim 7 wherein said talc is present at a concentration of from 1,000 to 10,000 ppm.

9. The polyethylene barrier film of claim 6 having a dusting whiteness rating which is at least 50% improved in comparison to a barrier film prepared under substantially the same film extrusion conditions in the absence of talc.

10. The polyethylene barrier film of claim 6 which comprising at least two film layers and wherein at least one of said at least two film layers is a skin layer which is prepared by the extrusion of a composition comprising (i) a high density polyethylene having a density of greater than 0.950 g/cc and (ii) from 500 to 20,000 ppm of talc.

11. A food package comprising sealed polyethylene barrier film according to claim 6.
